(19) United States
(12) Patent Application Publication
(10) Pub. No.: US 2021/0011560 A1
(43) Pub. Date: Jan. 14, 2021

(54) Wearable Device

(71) Applicant: Jun Ho Park, Gyeonggi-do (KR)

(72) Inventor: Jun Ho Park, Gyeonggi-do (KR)

(21) Appl. No.: 16/894,117

(22) Filed: Jun. 5, 2020

Related U.S. Application Data
(63) Continuation of application No. 15/557,787, filed on Sep. 12, 2017, now abandoned.

(30) Foreign Application Priority Data
Mar. 16, 2015 (KR) 10-2015-0035863

(51) Int. Cl. G06F 3/03; G01S 13/42; G01S 13/86; G06F 1/16; G06F 3/01; G06F 3/042; G01S 13/88; G06F 3/0346

(52) U.S. Cl. CPC G06F 3/0325; G01S 13/42; G01S 13/862; G06F 1/163; G06F 3/017; G06F 3/0304; G06F 2203/0331; G06F 3/014; G01S 13/867; G01S 13/88; G06F 3/011; G06F 3/0346; G06F 3/0425

(57) ABSTRACT

A wearable device and a method for determining a location of the wearable device are provided. The wearable device includes an image generator configured to generate an optical image for an object, a signal transceiver composed of a plurality of antennas to send and receive microwaves with respect to a location determined on the basis of the optical image, and a signal processor configured to calculate a spatial location of a target object through processing the received microwaves together with the optical image, wherein the signal processor detects an effective signal through analyzing properties of the received microwaves using the optical image and determines the spatial location of the target object through compensating for the effective signal with a value estimated by the optical image.

### CROSS REFERENCE TO RELATED APPLICATIONS

This application is a national stage application under 35 U.S.C. 371 of PCT/KR2016/002577 filed on Jan. 6, 2016 which claims the priority benefit of Republic of Korea application 10-2015-0035863 filed on Mar. 16, 2015, the disclosures of both are incorporated herein by reference.

### BACKGROUND OF THE INVENTION

### Field of the Invention

The present disclosure relates to a technology related to a wearable device.

### Description of the Related Art

Recently, the use of electronic devices has become essential in the daily life environment, and the electronic devices include respective input means. However, such general input means have not yet been greatly improved from two-dimensional (2D) input means, such as a keyboard and a mouse, and it is necessary to improve them for portability and convenience.

Accordingly, the advent of input means capable of satisfying both portability and convenience has been demanded. In particular, with the trend of miniaturization of electronic devices, new input means are necessary to process various input values so as to fully utilize functions of the electronic devices in addition to providing satisfaction for portability and convenience.

### SUMMARY OF THE INVENTION

The present disclosure has been made in order to solve the above problems, and an aspect of the present disclosure is to enable a portable device to accurately grasp a user's motion.

Another aspect of the present disclosure is to enable a wearable device to make various data inputs so that the wearable device can replace input means, such as a keyboard and a mouse.

Still another aspect of the present disclosure is to maintain precision of input data while maintaining portability, which is the advantage for a wearable device.

Technical aspects to be achieved by the present disclosure are not limited to those as described above, and other unmentioned technical subjects may be considered by those of ordinary skill in the art to which the present disclosure pertains from embodiments of the present disclosure to be described hereinafter.

In accordance with an aspect of the present disclosure, a wearable device includes an image generator configured to generate an optical image for an object; a signal transceiver composed of a plurality of antennas to send and receive microwaves with respect to a location determined on the basis of the optical image; and a signal processor configured to calculate a spatial location of a target object through processing the received microwaves together with the optical image, wherein the signal processor detects an effective signal through analyzing properties of the received microwaves using the optical image and determines the spatial location of the target object through compensating for the effective signal with a value estimated by the optical image.

The signal processor may calculate physical property values of the microwaves to be reflected from the target object on the basis of the generated optical image, and it may detect the effective signal through comparing the properties of the received microwaves with the calculated physical property values and filtering signals having no relation to the target object.

The signal processor may detect the effective signal through comparing signals having the same light-path length with each other among the received microwaves.

The signal transceiver may send a first microwave having a first frequency and receive a second microwave obtained as the first microwave is reflected from the target object, and the signal processor may determine a first phase angle of the second microwave having the first frequency through comparing a phase of the second microwave with a phase of a certain reference microwave having the first frequency or the microwave being sent with the first frequency and detect the effective signal through comparing phase differences between the first phase angle and a second phase angle determined by sending and receiving a microwave having a second frequency that is different from the first frequency.

The signal transceiver may send a first microwave having a specific frequency band and receive a second microwave obtained as the first microwave is reflected from the target object, and the signal processor may detect the effective signal through comparing a certain reference microwave and the second microwave with each other in a time domain or a frequency domain.

The signal transceiver may send a first microwave through modulating at least one of a frequency and a phase in a predetermined method in accordance with a time change and receive a second microwave obtained as the first microwave is reflected from the target object, and the signal transceiver may determine the spatial location from a value that is measured through comparing at least one of a frequency and a phase of the received second microwave with at least one of the modulated frequency and phase.

The effective signal may be a candidate value for the spatial location of the target object, and it may include at least one of information on a distance and a direction from the signal transceiver.

The signal transceiver may send the microwaves through a beamforming process for the plurality of antennas, and the signal processor may detect the effective signal in consideration of directivity of the received microwaves.

The plurality of antennas may constitute two or more antenna arrays, and each of the antenna arrays may send the microwaves through beamforming the microwaves in different directions.

The signal processor may detect the effective signal through comparing and analyzing the microwaves received through the two or more antenna arrays.

The image generator may generate the optical image using at least one of an infrared sensor, a depth sensor, and an RGB sensor, and the signal processor may estimate location information of the target object using information of the object included in the optical image.

The wearable device may sense an external surface through the image generator or the signal transceiver, the signal processor may determine whether the target object comes in contact with the external surface through comparing the spatial location of the target object with the external surface, and the wearable device may further include a key determinator configured to generate a key value corresponding to the spatial location of the target object when the target object comes in contact with the external surface.

The signal transceiver may send the microwaves toward the target object, and it may receive the microwaves that penetrate the object and are reflected from the target object.

The wearable device may further include a storage configured to store therein the optical image corresponding to the determined spatial location in a state where the optical image matches the spatial location.

If a spatial location is newly determined, the signal processor may load the optical image that matches the newly determined spatial location among the optical images stored in the storage.

The signal processor may determine 3D locations of a first joint connecting a user's palm to a first phalange of a finger and a second joint connecting the first phalange to a second phalange of the finger from the optical image for the object, and it may compensate for the effective signal on the basis of the 3D location values of the first joint and the second joint.

The signal processor may determine the 3D locations of the first joint and the second joint and bending angles of the first joint and the second joint, and it may compensate for the effective signal on the basis of the 3D location values of the first and second joints and the angles of the first and second joints.

In accordance with another aspect of the present disclosure, a method for determining a location of a wearable device includes generating an optical image for an object, sending a first microwave to a location determined on the basis of the optical image using a plurality of antennas, receiving a second microwave obtained as the first microwave is reflected from a target object, detecting a effective signal through analyzing properties of the second microwave using the optical image, and calculating a spatial location of the target object through compensating for the effective signal with a value estimated by the optical image.

According to embodiments of the present disclosure, the following effects can be expected.

First, a user can perform data input in an improved manner through the wearable device being capable of providing both portability and convenience.

Second, since the wearable device can replace the keyboard and the mouse, it is possible to perform inputs of various data using the wearable device only without additional input means.

Third, since the wearable device can maintain the precision of data input while maintaining the portability of the wearable device, an improved data input environment can be provided to the user.

Effects that can be obtained from embodiments of the present disclosure are not limited to those as described above, and other unmentioned effects may be clearly derived and understood by those of ordinary skill in the art to which the present disclosure pertains from the following description of the embodiments of the present disclosure. That is, unintended effects according to practice of the present disclosure may also be derived by those of ordinary skill in the art to which the present disclosure pertains from the embodiments of the present disclosure.

### BRIEF DESCRIPTION OF THE DRAWINGS

The accompanying drawings are to help understanding of the present disclosure and provide embodiments of the present disclosure together with the detailed description thereof. However, the technical features of the present disclosure are not limited to specific drawings, and the features disclosed in the respective drawings may be combined with each other to constitute new embodiments. In the respective drawings, reference numerals mean structural elements.

FIG. 1 is a block diagram illustrating the configuration of a wearable device according to an embodiment of the present disclosure;

FIGS. 2A and 2B are diagrams explaining the operation process of a wearable device according to an embodiment of the present disclosure;

FIG. 3 is a diagram explaining the operation process of a wearable device according to an embodiment of the present disclosure;

FIG. 4 is a diagram explaining the operation process of a wearable device according to an embodiment of the present disclosure;

FIG. 5 is a diagram explaining the operation process of a wearable device according to an embodiment of the present disclosure;

FIG. 6 is a diagram explaining an implementation example of a wearable device according to an embodiment of the present disclosure;

FIG. 7 is a diagram explaining an implementation example of a wearable device according to an embodiment of the present disclosure;

FIG. 8 is a diagram explaining an implementation example of a wearable device according to an embodiment of the present disclosure; and

FIG. 9 is a flowchart explaining a method for determining a location of a wearable device according to an embodiment of the present disclosure.

### DETAILED DESCRIPTION OF EXEMPLARY EMBODIMENTS

Terms used in the present disclosure are selected as general terms that are widely used at present in consideration of their functions in the present disclosure. However, such terms may differ depending on the intentions of those skilled in the art to which the present disclosure pertains, precedents, and advent of new technology. Further, some terms are optionally selected by the inventors; and, in this case, the meanings thereof will be described in detail in the corresponding description of the present disclosure. Accordingly, the terms used in the present disclosure should be defined on the basis of meanings that the terms have and the whole contents of the present disclosure rather than as titles of the terms.

In the embodiments below, constituent elements and features of the present disclosure are combined with each other in a specific form. Unless specifically mentioned, the respective constituent elements or features may be considered as selective ones. The respective constituent elements or features may be embodied in forms that are not combined with other constituent elements or features. Further, partial constituent elements and/or features may be combined to configure an embodiment of the present disclosure. The order of operations explained in embodiments of the present disclosure may be changed. Partial configurations or features according to one embodiment may be included in another embodiment, or they may be replaced by corresponding configurations or features according to another embodiment.

In the description of the drawings, procedures or steps that may obscure the gist of the present disclosure are not described, and procedures or steps to the extent that can be understood by those skilled in the art are also not described.

The term “comprising or including” used in the whole description means that one or more other constituent elements are not excluded in addition to the described constituent elements. Further, the term “˜unit”, “˜portion”, or “module”, as described in the description, means a unit that processes at least one function or operation, and it may be implemented by hardware, software, or a combination of hardware and software. Further, the term “connected to” that is used to designate a connection of one element to another element may include not only a physical connection but also an electrical connection, and further may mean a logical connection relationship.

Further, the terms “a or an”, “one”, “the”, and a similar related word may be used to include both a singular expression and a plural expression in the context that describes the present disclosure (particularly, in the context of the claims below) unless differently indicated in the description or clearly refuted by the context.

Further, in the description, the term “user” may be a wearer of a wearable device or a user and may include a technician who repairs the wearable device, but it is not limited thereto.

Hereinafter, preferred embodiments of the present disclosure will be described in detail with reference to the accompanying drawings. The detailed description to be disclosed hereinafter together with the accompanying drawings are to describe exemplary embodiments of the present disclosure, but they are not intended to present a unique embodiment that can be embodied by the present disclosure.

Further, specific terms used in embodiments of the present disclosure are provided to help understanding of the present disclosure, and the use of such specific terms may be changed to other forms without departing from the technical concept of the present disclosure.

Hereinafter, prior to the explanation of embodiments of the present disclosure, the contents of Korean Patent Application No. 10-2014-0108341 and the contents of Korean Patent Application No. 10-2014-0139081 are all incorporated by reference in the description of the present disclosure. Korean Patent Application No. 10-2014-0108341 proposes an invention in which a 3D model is generated through 3D scanning of an object using a wearable device and a user's motion is sensed through addition of a pattern to the 3D model. Korean Patent Application No. 10-2014-0139081 proposes an invention in which a user's motion is sensed by analyzing a user's vascular pattern through transmission/reception and comparison of light signals having different wavelengths.

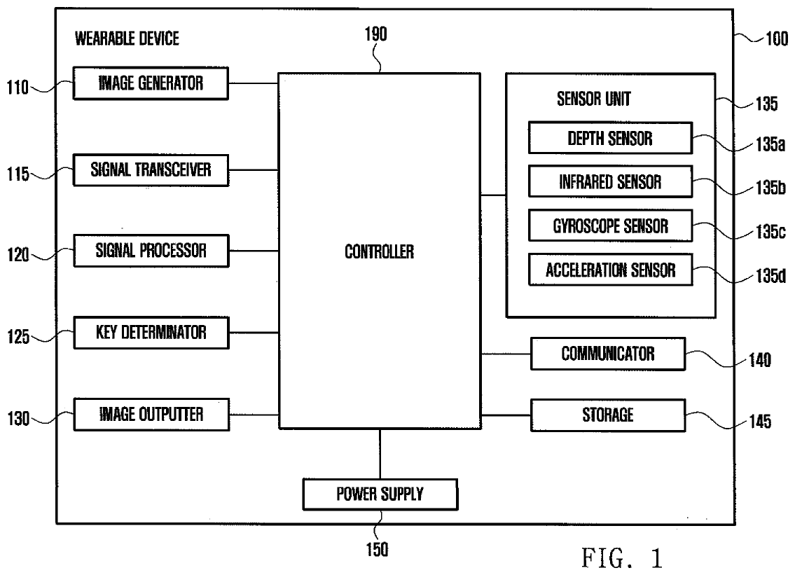

FIG. 1 is a block diagram illustrating the configuration of a wearable device according to an embodiment of the present disclosure.

The block diagram illustrated in FIG. 1 is merely an embodiment implementing a wearable device 100, and the wearable device 100 may be implemented by configurations that are smaller than the configurations as illustrated in FIG. 1 or may further include other general-purpose configurations. That is, the implementation type or the scope of the wearable device 100 is not limited to the contents as illustrated and described in FIG. 1.

The wearable device 100 is an input/output means mounted on a part of a user's body (e.g., face or hand). The wearable device 100 senses a user's body motion using various means, and it generates data and signals according to an action that is formed by the sensed motion. The wearable device 100 may operate as an input means for an external device through transmission of the generated data and signals to the external device or a server. Further, the wearable device 100 may operate as an output means for outputting the data generated and processed by itself or data received from outside. In the case of operating as the output means, the wearable device 100 may output the processed data in various types, such as a text, still image, and moving image.

Hereinafter, various configurations included in the wearable device 100 will be described. The wearable device 100 according to an embodiment may include an image generator 110, a signal transceiver 115, a signal processor 120, a key determinator 125, an image outputter 130, a sensor unit 135, a communicator 140, a storage 145, a power supply 150, and a controller 190. The illustrated configurations may be connected to each other by wire or wirelessly to send to and receive from each other data and signals. As described above, the configurations illustrated in FIG. 1 are merely examples for implementing the wearable device 100, and the wearable device 100 may be implemented to include configurations that are smaller or larger than the above-described various configurations.

The image generator 110 generates an optical image for an object. The object means an object for which the image generator 110 generates an optical image using various kinds of sensors included in the sensor unit 135 to be described later, and the object may be a thing or a part of a human body. For example, the optical image generated by the image generator 110 may be a user's hand, and it may be an external surface or a desk that the user's hand comes in contact with. Meanwhile, the optical image means a 2D or 3D image for the object. The optical image may be a still image or a moving image for the object, and it may be an image obtained as the image generator 110 directly captures the image of the object or a virtual image generated through data analysis.

The image generator 110 may generate the optical image for the object in various ways. For example, the image generator 110 may generate the optical image for the object through measuring a distance from the object using a depth sensor 135a included in the sensor unit 135. Further, the image generator 110 may generate the optical image for the object by sending a light signal in the near-infrared region through an infrared sensor 135b. Further, the image generator 110 may generate the optical image through grasping a spatial motion of the wearable device 100 from a specific reference point using a gyroscope sensor 135c and an acceleration sensor 135d with respect to initial data generated in association with the depth sensor 135a, an RGB sensor, or the infrared sensor 135b. The above-described image generation methods are merely exemplary, and the image generator 110 may generate the optical image for the object using various ways in addition to the above-described methods. A method using the RGB sensor (not illustrated) may also be applied.

The signal transceiver 115 sends and receives microwaves. The microwaves are electromagnetic waves in the bands of 300 MHz to 300 GHz and belong to short waves having short wavelengths. The signal transceiver 115 sends the microwaves to a target object and receives the microwaves reflected from the target object. The microwaves may be sent in the form of continuous waves (CW) or pulse waves (PW), to have a specific frequency, or in the form of a wideband having a specific frequency band.

The signal transceiver 115 may use an ultrasound signal in addition to the microwaves. The signal transceiver 115 implemented to include an ultrasound imaging sensor may send and receive ultrasound waves in the form of waves equal to or higher than 20 KHz to achieve a purpose similar to that of the microwaves. In the contents using the microwaves as described above and the contents to be described later, a method in which microwaves are sent to a location that is based on an optical image, physical properties of the received microwaves are analyzed, and an effective signal is detected on the basis of distance and direction information and a method in which a spatial location of a target object is determined through compensating for the effective signal with a value estimated by the optical image may be equally or similarly applied in an embodiment using the ultrasound imaging sensor. Further, the location or image of the target object that is obtained using the ultrasound sensor may be stored to match the optical image, and if a spatial location is newly determined, an optical image or an ultrasound image corresponding to the location may be loaded.

Although the microwaves sent from the signal transceiver 115 may be transmitted to the target object without any obstruction, another object located between the signal transceiver 115 and the target object may act as an obstacle. For example, if the signal transceiver 115 sends the microwaves from a user's finger tip, an object, such as the back of a user's hand or another finger, may act as an obstacle depending on the location of the signal transceiver 115. In this case, the microwaves penetrate the object and are transferred to the target object. The microwaves transferred to the target object through penetrating the obstacle are reflected by the target object, and the signal transceiver 115 receives the microwaves reflected from the target object. The reflected microwaves may penetrate the obstacle again in the process in which the microwaves are received from the target object to the signal transceiver 115.

On the other hand, the signal transceiver 115 may be configured to include a plurality of antennas. Each of the plurality of antennas may be designed to send and receive the microwaves, and two or more of the plurality of antennas may be gathered to form antenna arrays. That is, the signal transceiver 115 may include two or more antenna arrays, and each of the antenna arrays may include two or more antennas.

The antenna array may be a unit for performing beamforming of the microwaves. That is, a beamforming process is performed to send the microwaves in a specific direction, and the respective antenna arrays send the microwaves in desired directions through performing the beamforming process in different directions. If the microwaves sent through the beamforming are received, the signal processor 120 to be described later may analyze directivity of the received microwaves. On the other hand, the beamforming may be performed using both an analog beamforming method (change of an antenna design, a phase array type, and an antenna arrangement type, or attachment of an electromagnetic shielding material) for adjusting the antenna array itself or the physical direction in which the microwaves are sent and a digital beamforming method for mathematically adjusting the direction of the microwaves through calculation of equations and matrices.

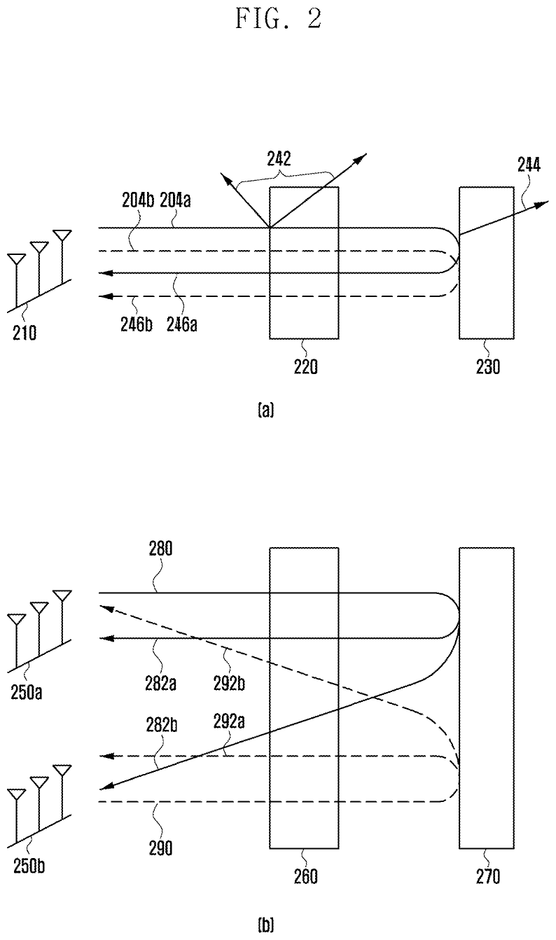

Further, the antenna array may be a reference unit processing the received microwaves. In this case, the microwaves received through the respective antenna arrays are processed as one group, and the detailed embodiment thereof will be described with reference to FIGS. 2A and 2B.

The signal processor 120 determines the spatial location of the target object through processing the microwaves received by the signal transceiver 115. That is, the signal processor 120 analyzes physical property values (e.g., a frequency, phase, strength, polarization, pulse length, and microwave arrival time (total flight time)) of the microwaves received through being reflected from the target object, and it determines the spatial location of the target object on the basis of the analyzed property values. The spatial location means a 3D location and may be coordinates considering a specific location of the wearable device 100 as the origin.

On the other hand, the signal processor 120 may use the optical image generated by the image generator 110 in determining the spatial location of the target object. Specifically, the signal processor 120 primarily determines spatial location values through analyzing the microwaves received by the signal transceiver 115. Such primary resultant values are called effective signals, and the effective signals become candidate values for the final resultant value. Although the effective signal is the resultant value using the microwaves only, it includes all information on the target object, and it includes information on a location relationship (i.e., distance and direction) between the signal transceiver 115 and the target object.

A process in which the signal processor 120 detects the effective signal may be understood as a process of selecting only a significant value among several locations having distances from the signal transceiver 115 to the target object. In other words, the process of detecting the effective signal may be understood as a process of filtering insignificant signals that do not include information on the target object because the microwaves are unable to reach the target object and are scattered. That is, if a distance from the signal transceiver 115 to the target object is measured, a plurality of candidate locations having the corresponding distance are specified. Since the signal transceiver 115 knows the direction in which the microwaves are sent, the plurality of candidate locations are not infinite. However, in order to precisely measure the spatial location, it is necessary to further reduce the number of candidate locations, and such a process may mean the process of detecting the effective signal. As examples of the process of detecting the effective signal, a method for transmitting two or more microwaves having different frequencies, a method for transmitting and receiving microwaves having a wide frequency band, and a method for transmitting microwaves through beamforming by antenna arrays may be singly or compositely utilized. The details thereof will be described later.

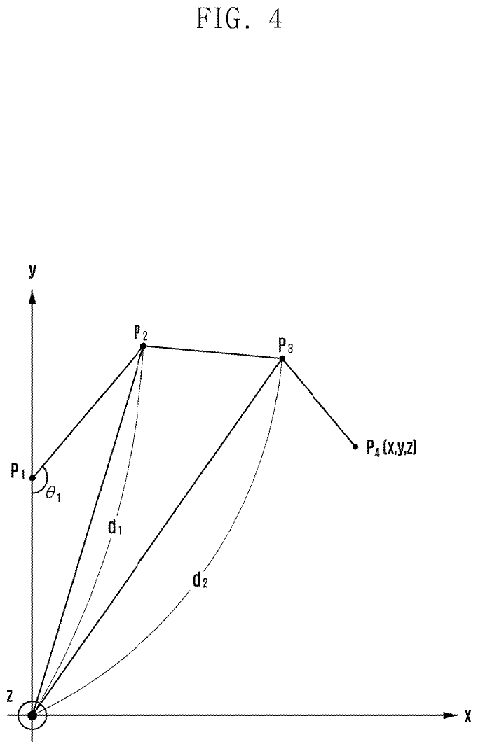

Then, the signal processor 120 compensates for the effective signal using an optical image. Specifically, if the image generator 110 generates the optical image, the signal processor 120 may estimate a 3D location range for the target object through a process of analyzing the optical image (detailed algorithm will be described with reference to FIG. 4). The signal processor 120 may determine the spatial location of the final target object through compensating for the effective signal that is the primary result using the value estimated using the optical image. Through compensating for the effective signal through the optical image, precision of the resultant value can be heightened as compared with a case where only the microwaves are used, and the calculation speed can also be improved. That is, on the basis of the point that the effective signal includes a part of the location value of the optical image of the target object, the received effective signal is compensated for through the optical image having high precision; thus, it is possible to precisely determine the location of the target object.

Although the description states that the image generator 110 generates the optical image of the object and the signal transceiver 115 transmits the microwaves to the target object, the operation of the wearable device 100 is not limited thereto. As described above, the target object of the wearable device 100 may be a thing other than a part of the user's body. That is, the wearable device 100 may also sense an external surface that interacts with a part of the user's body. The image generator 110 may generate the optical image for the external surface using the sensor unit 135, and the signal transceiver 115 may also send the microwaves to the external surface and receive the microwaves reflected from the external surface to enable the signal processor 120 to calculate the spatial location for the external surface.

If a user's key input operation is sensed, the key determinator 125 generates an input value matching the key input operation. The key input operation is an operation for the target object (e.g., user's finger tip) to touch the external surface, and a case where the spatial location of the target object comes in contact with the external surface within a predetermined distance as a result of data analysis by the signal processor 120 may be considered to be a case where the key input operation is sensed. Further, the key input operation may include all cases where a finger is bent over a predetermined angle even if the finger does not come in direct contact with the external surface. That is, if an operation that is similar to a case where the finger comes in contact with the external surface is performed in the air, it may correspond to the key input operation even if the finger does not come in contact with the external surface.

If the signal processor 120 senses the key input operation as described above, the key determinator 125 generates an input value corresponding to the spatial location of the target object. The generated input value may be internally processed in the wearable device 100, or it may be transmitted to an external device or server so as to make the wearable device 100 operate as an input means.

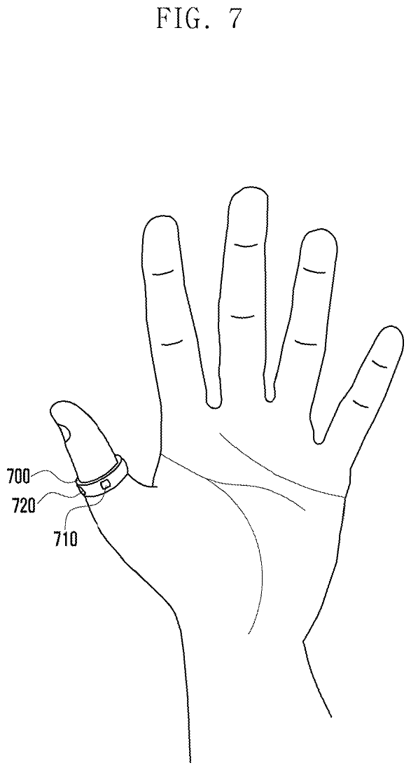

The image outputter 130 projects an image to the outside. The image outputter 130 may output the image to the outside, such as to a thing or a part of the body, and such objects are not limited. For example, the image outputter 130 may project the image onto the palm, the back of a hand, or an arm that is a part of the body, and it may project the image onto a thing, such as a desk or a wall surface. The images projected by the image outputter 130 may include all kinds of images, such as a certain image, moving image, and 3D image (stereoscopic image). The image may be projected onto an eye (i.e., eyeball) as another example of a part of the body. This embodiment will be further described with reference to FIG. 7.

Meanwhile, in the process of projecting the image, the image outputter 130 may cause the output image to be projected onto a constant location with a constant size, even if the wearable device 100 moves, using the result of calculating location information of the object through the signal processor 120. In other words, the 3D location information of the target object that is calculated by the signal processor 120 may become a specific reference point, and the image outputter 130 may determine an external object onto which the image is to be projected through continuously tracking the 3D location of the target object. The image outputter 130 may change an angle and a location for outputting the image so that the image can be constantly projected through calculating a distance and an angle of the external object on the basis of the target object.

The sensor unit 135 includes various kinds of sensors used for the operation of the wearable device 100. In an embodiment, the sensor unit 135 may include the depth sensor 135a, the infrared sensor 135b, the gyroscope sensor 135c, and the acceleration sensor 135d, and it may additionally include various kinds of sensors. The sensors included in the sensor unit 135 may be used for the image generator 110 to generate the optical image for the object, or they may be used for the signal transceiver 115 to send and receive the microwaves. Further, the sensor unit 135 may be used in the process in which the signal processor 120 calculates the 3D location of the target object using the received microwaves. Although not illustrated, the sensor unit 135 may also include the RGB sensor as described above.

The depth sensor 135a may perform 3D scanning of the object, and it may include a time of flight (ToF) camera using an ultrasound signal or a light signal, a laser transceiver using a laser signal, and a stereo camera that is a type of camera photographing the object at two locations. In addition, the depth sensor 135a may include sensors that are used for a structured light type using a near-infrared pattern, a type using a predetermined or programmed light pattern, a light detection and ranging (LIDAR) type emitting a pulse laser light, and a speckle interferometry type sensing a change of a coherent light that is reflected from the surface of the object.

The infrared sensor 135b is a sensor scanning the object using a light signal of an infrared region, and it may include an infrared camera that sends an infrared signal to the object and senses a change on the surface of the object and a sensor using an infrared proximity array (IPA) type.

The depth sensor 135a for 3D scanning of the object and the infrared sensor 135b are not limited to the exemplified configurations as described above, and other various configurations may be included in the depth sensor 135a. Further, the depth sensor 135a may also be implemented in the form in which two or more of the above-described configurations are combined.

After the depth sensor 135a and the infrared sensor 135b scan the object, the image generator 110 may improve precision of the optical image using a computer vision technique. The computer vision technique is used for the purpose of improving precision of the depth information in the process of analyzing a 2D image and includes a depth-from-focus type, a depth-from-stereo type, depth-from-shape type, and a depth-from-motion type. The image generator 110 can precisely generate the optical image for the object using the above-described various types.

The image generator 110 may also use the gyroscope sensor 135c and the acceleration sensor 135d. The gyroscope sensor 135c measures a motion direction and a slope of the wearable device 100. Since the kind and the function of the gyroscope sensor 135c are well known to those of ordinary skill in the art, a detailed explanation thereof will be omitted. The acceleration sensor 135d senses a motion distance, speed, and acceleration of the wearable device 100 through measurement of a speed change. Since the kind and the function of the acceleration sensor 135d are also well-known in the art, a detailed explanation thereof will be omitted.

The gyroscope sensor 135c and the acceleration sensor 135d measure a 3D spatial motion of the wearable device 100. That is, the gyroscope sensor 135c and the acceleration sensor 135d measure in what direction, speed, and slope the wearable device 100 moves in a 3D space; thus, they enable the signal processor 120 to calculate a relative location of the wearable device 100 to the specific reference location.

Meanwhile, the key determinator 125 may also sense a user's mouse input operation using the gyroscope sensor 135c and the acceleration sensor 135d. The mouse input operation means a user's input to operate a cursor of a mouse as the user moves the wearable device 100 in the space in a state where the wearable device 100 is mounted on the user. The above-described key determinator 125 may generate a cursor value matching the mouse input operation through sensing the spatial motion of the wearable device 100 using measurement values sensed by the gyroscope sensor 135c and the acceleration sensor 135d.

If the target object (user's finger tip) comes in contact with another target object (e.g., another finger tip or an external surface) during sensing of the mouse input operation, the key determinator 125 may determine that a mouse click operation to click the left or right button of the mouse is sensed. For example, the wearable device 100 may recognize a case where a user's thumb and index finger come in contact with each other as a click of the left button of the mouse, and it may recognize a case where a user's middle finger and thumb come in contact with each other as a click of the right button of the mouse. On the other hand, the corresponding clock operation generates a mouse click value, and the mouse click value may be transmitted to an external device or server together with the cursor value of the mouse input operation.

The communicator 140 performs data communication and performs transmission and reception with the outside. For example, the communicator 140 may be wirelessly connected to an external network to communicate with the external device or server, and it may include one or more communication modules for performing communication.

The communicator 140 is a module for short-range communication, and it may include modules for implementing a communication function, such as wireless LAN, Wi-Fi, Bluetooth, Zigbee, Wi-Fi direct (WFD), ultra wideband (UWB), infrared data association (IrDA), Bluetooth low energy (BLE), and near field communication (NFC).

The communicator 140 may transmit the input value, cursor value, and clock value generated by the key determinator 125 to the outside using the above-described communication modules. Further, the communicator 140 may receive 3D location information from an external device through the above-described communication modules.

The storage 145 may store therein data and information input/output through the wearable device 100. For example, the storage 145 may store the input value, cursor value, and click value generated by the key determinator 125. Further, the storage 145 may store various kinds of program data or algorithm data that can be executed by the wearable device 100. Further, the storage 145 may store spatial location information of the target object calculated by the signal processor 120 in a state where the spatial location information matches the optical image.

The storage 145 may include at least one storage medium of a flash memory type, multimedia card micro type, or card type memory (e.g., SD or XD memory), a random access memory (RAM), a static random access memory (SRAM), a read-only memory (ROM), an electrically erasable programmable read-only memory (EEPROM), and a programmable read-only memory (PROM). Further, the wearable device 100 may operate a web storage or a cloud server that performs the storage function of the storage 145 on the Internet.

The power supply 150 supplies a power for the operation of the wearable device 100. The power supply 150 may include various kinds of power supply means, such as a Li-ion battery and Li-polymer battery, and the wearable device 100 may include a plurality of power supplies 150. The power supply 150 may be connected to other configurations of the wearable device 100 by wire to supply the power thereto, and it may wirelessly receive a supply of an external power through wireless power transfer technology to be charged. Further, the power supply 150 may also include a flexible battery that can be flexed or unflexed over a predetermined degree. Further, the power supply 150 may receive a supply of energy from a user's body on which the wearable device 100 is mounted, and it may generate a power for the operation of the wearable device 100. That is, the power supply 150 may generate and supply the power required for the operation of the wearable device 100 using heat that is transferred from the user's body coming in contact with the wearable device 100.

The controller 190 is connected to the above-described configurations to control the overall operation of the wearable device 100. For example, the controller 190 may control the signal processor 120 to analyze both the optical image generated by the image generator 110 and the microwaves received by the signal transceiver 115, and it may control the key determinator 125 to generate the input value in accordance with the calculation result of the signal processor 120. That is, the controller 190 may control various functions for the wearable device 100 to operate as an input means or an output means in accordance with the user's operation.

Hereinafter, explanation will be made with respect to an embodiment in which the wearable device 100 operates in accordance with a motion of a user's body. The wearable device 100 may be implemented in various shapes, for example, the wearable device 100 may be implemented in the shape of glasses worn by a user, a ring mounted on a user's finger, a watch or a bracelet mounted on a user's wrist, or a clip mounted on a necktie or clothes. However, such implementation shapes are merely exemplary.

Further, the wearable device 100 may be implemented in two or more separated shapes. That is, all the configurations as illustrated in FIG. 1 may be included in any one or two or more separated wearable devices 100, and the two or more separated wearable devices 100 may interlock with each other to send to and receive from each other data. In other words, the wearable device 100 may be implemented in the shape that includes a part or the whole of the configurations as illustrated in FIG. 1; and, if the wearable device 100 includes a part of the configurations, it may interlock with another wearable device 100 that includes another part of the configurations.

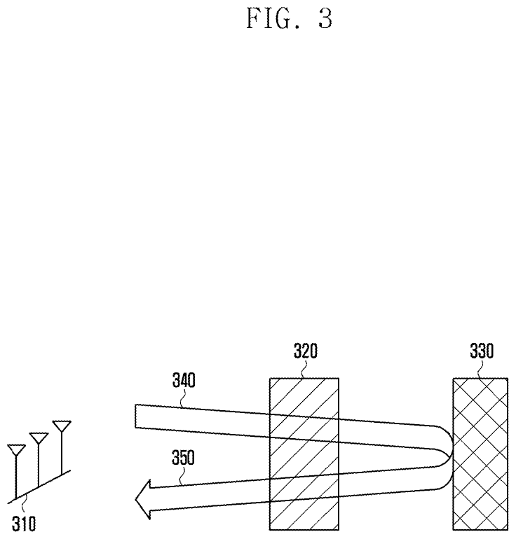

FIGS. 2A, 2B, and 3 are diagrams explaining the operation process of a wearable device according to an embodiment of the present disclosure. With reference to FIGS. 2A, 2B, and 3, an embodiment in which a wearable device sends and receives microwaves and a process of detecting an effective signal through analysis of the received microwaves will be described. With reference to FIG. 2A, an explanation will be made on the basis of one antenna array; and, with reference to FIG. 2B, an explanation will be made on the basis of a plurality of antenna arrays.

With reference to FIG. 2A, an antenna array 210 transmits microwaves to a target object 230. With reference to FIG. 2A, the antenna array 210 may send to the target object 230 a first microwave 240a having a frequency f1 and a second microwave 240b having a frequency f2, and it may send more microwaves in addition to the two microwaves as illustrated. In sending the microwaves, the antenna array 210 may pre-calculate a phase difference between a phase angle of the first microwave 240a and a phase angle of the second microwave 240b. Information on the calculated phase difference is used to analyze the received microwaves. Hereinafter, a process of determining the phase angles of the microwaves and the phase difference will be described in detail.

With reference to FIG. 2A, the transmitted microwaves penetrate an obstacle 220 and are transmitted to the target object 230. A part of the microwaves is reflected, scattered, and absorbed on the obstacle 220 (242), and a part of the microwaves having arrived at the target object 230 may also be reflected, scattered, and absorbed (244). Meanwhile, the microwaves reflected from the target object 230 penetrate the obstacle 220 again and are received in the antenna array 210 (246a and 246b).

Meanwhile, the antenna array 210 sends the microwaves in the form of PW or CW; and, because the microwaves that are continuously sent pass through the above-described reflection and scattering processes, they are non-periodically and irregularly received in the antenna array 210. Accordingly, a filtering process should be additionally carried out in order to calculate the location of the target object 230 from the received microwaves 246a and 246b.

First, the phase angles of the first microwave 246a and the second microwave 246b that are received through the antenna array 210 are determined. If the first microwave 246a is received in the antenna array 210, the phase of a reference microwave having the frequency f1 of the first microwave 240a or 246a is compared with the phase of the received first microwave 246a. For example, the phase of the received first microwave 246a is compared with the phase of the microwave that is currently sent with the frequency f1 by the antenna array 210 or is compared with the phase of the reference microwave that is the microwave on the assumption that the microwave is reflected at a certain reference location. The result of comparing the phase of the received first microwave 246a with the phase of the reference microwave or the phase of the microwave being sent becomes the phase angle of the first microwave 246a. In the same manner, the phase of the second microwave 246b having the frequency f2 may also be compared with the phase of the microwave that is currently sent with the frequency f2 by the antenna array 210 or may be compared with the phase of the reference microwave having the frequency f2, and the phase difference that is the result of the comparison becomes the phase angle of the second microwave 246b.

The antenna array 210 detects an effective signal through calculating the phase difference between the received first microwave 246a and the second microwave 246b. Specifically, the antenna array 210 calculates the phase difference through comparing the phase angle of the first microwave 246a with the phase angle of the second microwave 246b.

The first microwave 246a and the second microwave 246b are received through the same optical path length (OPL); thus, a distance value to the target object can be derived by calculating the phase difference that is a difference between the phase angles of the two microwaves. In other words, the phase difference that is the difference between the phase angles of two microwaves having different frequencies, which are received through the same optical path length, is in proportion to an actual distance value. Since the phase difference is in proportion to the distance value of the actual optical path, the actual distance value can be converted from the calculated phase difference.

Meanwhile, if the distance value to the target object is calculated from the phase difference in accordance with the above-described calculation process, the calculated distance value corresponds to two candidate locations. That is, in a situation that information on the direction toward the target object is not confirmed exactly, one candidate value is further obtained in addition to the distance value corresponding to the effective signal as a result using only the phase angle of the microwave having the frequency f1 and the phase angle of the microwave having the frequency f2. Such a candidate value is a false value that is not related to the distance of the actual target object, and it can be removed through additionally acquiring information on a variable in the calculation process. That is, the antenna array 210 can finally acquire information on two phase differences by repeatedly performing the further obtaining of one phase difference through transmitting the microwaves having frequencies f3 and f4, or obtaining of the phase difference through transmitting once more the microwaves having the frequencies f1 and f2, and one common value among the total four distance candidate values calculated from the two phase differences becomes the value indicating the distance of the final target object.

In summary, two or more microwaves are sent with respect to two or more frequencies through the antenna array 210. Then, the phase difference is calculated from the result of comparing the phase angles of the microwaves having the same optical path length with each other among the microwaves received through the antenna array 210, and the final distance value to the target object can be acquired by substituting distance information for the phase difference result. As described above, data finally calculated with respect to the distance and the location of the target object 230 is called the effective signal, and it includes information on the location for the target object 230 (i.e., distance and direction from the antenna array 210). The wearable device may determine the spatial location of the target object 230 through analyzing the detected effective signal, and a detailed determination process will be described later.

FIG. 2B illustrates an embodiment for a plurality of antenna arrays 250a and 250b. The first antenna array 250a transmits a first microwave 280 having a frequency f1 to a target object 270, and the second antenna array 250b transmits a second microwave 290 having a frequency f2 to the target object 270. For convenience in explanation, although it is illustrated that each of the antenna arrays transmits only one microwave, two or more microwaves may be transmitted to the target object 270 as illustrated and described in FIG. 2A.

The first microwave 280 sent from the first antenna array 250a arrives at the target object 270 after passing through the obstacle 260, and it is reflected from the target object 270 to be received in the first antenna array 250a (282a). A part of the first microwave 280 reflected from the target object 270 is received in the second antenna array 250b (282b). Similarly, the second microwave 290 sent from the second antenna array 250b is reflected from the target object 270, and a part thereof is received in the second antenna array 250b while another part thereof is received in the first antenna array 250a (292a and 292b). Along with the above-described process, a process of additionally sending and receiving the microwaves having frequencies f11 and f22 that are different from the frequencies f1 and f2 through the respective antennas may be carried out as described above.

The first antenna array 250a may determine the spatial location of the target object 270 as described above with reference to FIG. 2A through comparing the microwave having the frequency f1 with the microwave having the frequency f11. On the other hand, the first antenna array 250a also receives the microwave having the frequency f2 and the microwave having the frequency f22 that are sent from the second antenna array 250b. Similarly, the second antenna array 250b receives not only the microwave having the frequency f1 and the microwave having the frequency f11 that are sent from the first antenna array 250a, but it also the microwaves having the frequencies f2 and f22 that are sent from the second antenna array 250b. Accordingly, the wearable device can grasp the distance of the target object 270 more precisely through analyzing both the microwaves that are received from the first antenna array 250a and the second antenna array 250b.

That is, the first antenna array 250a may calculate the difference between the phase angles of the microwaves (having the frequencies f2 and f22) by the second antenna array 250b. Since the microwave having the frequency f2 and the microwave having the frequency f22 have the same optical path length, the calculated distance is located on a spatial ellipse. In contrast, if the microwaves (having the frequencies f1 and f11) by the first antenna array 250a have the same frequencies as the microwaves (having the frequencies f2 and f22) by the second antenna array 250b, interference due to the difference between their optical paths occurs in the microwaves having the frequencies f1, f11, f2, and f22 that are received in the first antenna array 250a. If the two microwaves form a constructive interference, the phase difference between the f1 and f2 microwaves and the phase difference between the f11 and f22 microwaves are minimized, whereas if the two microwaves form a destructive interference, the phase difference between the f1 and f2 microwaves and the phase difference between the f11 and f22 microwaves are maximized. The first antenna array 250a compares microwave components successively received from the second antenna array 250b with microwave components successively received from the first antenna array 250a to detect a case where the phase difference is minimized and a case where the phase difference is maximized, and it may specify the location of the target object 270 that is apart from the first antenna array 250a and the second antenna array 250b for a constant optical path difference on a hyperbola.

Further, by applying a frequency domain distance measurement method using a wideband frequency to be described later, it is possible to obtain a correlation between the microwave components (component by the first antenna array 250a and component by the second antenna array 250b) that are received from the first antenna array 250a through determining them as a received frequency band and a reference frequency band; and, by applying a frequency-time conversion algorithm to the resultant value, it is possible to obtain a point located apart from the two antenna arrays 250a and 250b for a constant optical path difference.

In the same manner, the second antenna array 250b may also calculate the phase angle difference or interference between the microwaves (having the frequencies f1 and f11) by the first antenna array 250a similarly to the contents as described above.

The microwaves are transmitted with a repeated phase in a constant period (in the case of PW, with pulse repetition frequency (PRF)), and if the phase difference between the received microwaves is known, it is possible to calculate the optical path length to the target object along with calculation of the transmission speed of the microwaves. Although the optical path length determined at one location has many candidate groups in the shape of a sphere in space, the candidate groups may be compressed using analysis of two or more frequencies together as described above with reference to FIG. 2A, or they may be further compressed through analysis of the microwaves received at two or more locations together as described above with reference to FIG. 2B. Accordingly, it is possible to specify the spatial location of the target object.

In the case of calculating the phase difference through comparison of the microwaves having the same optical path length in one antenna as described above with reference to FIG. 2A, the candidate values in the spatial location of the target object form a spherical shape in space. In contrast, in the case of calculating the phase difference through comparison of the microwaves having the same optical path length in two antennas as described above with reference to FIG. 2B, the candidate values form an elliptical shape in space. If a calculation process to subtract the measured distance from the spherical or elliptical candidate group is carried out once more, the resultant value forms a hyperbola, and the target object is located on the hyperbola. As described above, if directivity of the microwaves is determined in the shape of a sphere or a spatial ellipse, the wearable device can extract the effective signal among the candidate values, and a method for determining such directivity may be carried out through a beamforming process to be described below. In the case of a hyperbola, the curvature thereof is not great; thus, the hyperbola may be processed similar to a straight line. It may be analyzed that the hyperbola having no great curvature includes information on a specific directivity. In this case, even if the beamforming process to be described later is omitted, it is possible to specify the spatial location of the target object even through a process of processing the received signal in a time domain or a frequency domain.

On the other hand, the antenna array may transmit the microwaves through beamforming the microwaves. The beamforming is a process of adding directivity to the microwaves being transmitted, and may be performed through specifying the structure of the antenna itself as described above or through a mathematical process to calculate a beamforming matrix. Each antenna array is a unit for beamforming the microwaves in a specific direction, and different beamforming processes are carried out through different antenna arrays. With reference to FIG. 2B as an example, the beamforming in the first antenna array 250a and the beamforming in the second antenna array 250b are carried out differently from each other. The wearable device may include three or more antenna arrays, and different beamforming processes may be applied to the respective antenna arrays.

Meanwhile, the microwaves that are beamformed to be transmitted have directivity; and, through comparing the beamformed microwaves with the received microwaves, the direction to the target object as well as the distance can be known. That is, through the beamforming process, the spatial location of the target object that is calculated in the respective antenna arrays can be specified more precisely.

A frequency modulation or phase modulation technique may be applied to the microwaves. The frequency modulation or phase modulation momentarily transmits the microwaves with different frequencies/phases rather than fixing and using a specific frequency/phase. As a frequency modulation method and a phase modulation method, linear modulation, non-linear modulation, and encoded pulse phase modulation methods may be applied, and reliability for the resultant value may be further improved in accordance with a frequency change and a phase change. The frequency modulation and the phase modulation may be carried out together.

Specifically, the antenna array transmits the microwaves through modulating the frequency or phase into a predetermined pattern in accordance with time, and it receives the microwaves that are reflected from the target object. Since the frequency or phase of the microwaves is changed in accordance with the pattern already known by the wearable device, the signal processor can confirm at what time the corresponding microwaves were transmitted through analyzing the frequency or phase of the reflected microwaves. If information on the transmission time of the pre-transmitted microwaves is acquired from the frequency or phase of the received microwaves as described above, the optical path length can be known through calculating both the transmission speed and an arrival time of the microwaves, and distance information from the transceiver to the target object can be acquired. That is, the wearable device can detect the effective signal in accordance with the above-described frequency modulation method. If the frequency or phase modulation method as described above is used, the process of calculating the phase difference through comparing the microwaves having two or more frequencies as described above with reference to FIG. 2A can be omitted. That is, even if there is no reference microwave having a certain reference frequency, the distance to the target object can be calculated using the transmitted/received microwaves only. In contrast, in the case of sending a plurality of frequencies by the frequency or phase modulation method as described above, the distance may be calculated through determining the phase angles of the microwaves having the modulated frequency or phase and obtaining the phase difference using the phase difference method. In the case of implementation using two or more antenna arrays, the above-described contents may be similarly applied.

The wearable device may change the frequency or the pulse repetition frequency of the microwaves sent in the same direction or in a different direction through the frequency modulation process, and the difference in strength, phase, and polarization degree between the transmitted and reflected microwaves may be stored in association with the spatial image of the target object. As a result, by only analyzing the properties of the reflected waves that are reflected from the target object after passing through the obstacle in accordance with the frequencies thereof, precision can be heightened in obtaining the image of the target object. Further, the incident angle of the microwaves may also be stored in association with the spatial image. The reflection rate of the reflected microwaves differs in accordance with the incident angle and polarization of the microwaves, and in the case of storing information on the incident angle of the microwaves, it may be utilized in analyzing new microwaves.

In contrast with FIGS. 2A and 2B, FIG. 3 is a diagram explaining an embodiment using a wideband frequency rather than a specific frequency. If an antenna array 310 sends microwaves 340 having a specific frequency band to a target object 330, microwaves 350 that are received through an obstacle 320 also have the frequency band. The microwaves being sent or received may have a narrow band frequency or a wide band frequency, and a wearable device may utilize an ultra wide band (UWB) radar technique for measuring a distance or generating an image using a wide band frequency.

First, a method for utilizing a wide band frequency in a time domain will be described. The microwave of a specific frequency band that is received by the antenna array 310 is compared with a reference microwave having the same frequency band. The reference microwave is a certain microwave generated on the assumption that the microwave is reflected in a location that is apart from the antenna array 310 for a predetermined distance. Both the received microwave and the reference microwave are microwaves having a wide band frequency component, and they are analyzed through comparison or synthesis in a time domain or a frequency domain. Such a comparison process may be carried out through a process of calculating a correlation between the two microwaves. High correlation between the two microwaves means that a reference location of the reference microwave is similar to the same extent to the location of the actual target object, and low correlation means that a difference between the reference location and the spatial location of the target object is relatively high.

Next, a method for utilizing a wide band frequency in a frequency domain will be described. If a microwave having a specific frequency band is received, a correlation between the received microwave having the frequency band and a microwave having a certain reference frequency band is obtained, and the result is expressed as a specific waveform in the frequency domain. By applying a frequency-time conversion algorithm (e.g., Fourier transform algorithm) to such a new waveform, several waveforms can be converted into distance information in the frequency domain.

As an example for actually implementing the wide band frequency, a distance measurement method based on the wide band frequency may be implemented through a method for transmitting pulses in which the frequency band is constantly increased according to time.

Through the above-described time domain method or frequency domain method, or a time-frequency domain mixing method (a method in which one frequency is shot out at the same time and is changed according to time). One or more reference microwaves may be used in a repetition process, and precision can be improved in detecting the effective signal through comparing the received microwave with several reference microwaves.

Meanwhile, although only a single antenna array 310 is illustrated in the embodiment of FIG. 3, the contents as described above with reference to FIGS. 2A and 2B may be similarly applied in the case of implementation using two or more antenna arrays. As described above, the flight distance of the microwaves (i.e., distance to the target object) has been calculated through calculating the flight time of the received microwave using a phase difference, frequency band, phase, or frequency modulation method. However, the wearable device may also confirm the distance to the target object by first determining the flight time of the microwave, calculating a phase difference, frequency band, frequency or phase modulation value that matches the flight time, and comparing the calculated value with the received signal value.

Further, in order to divide the frequencies of the microwaves being sent or received more precisely, the wearable device may modulate physical values of the microwaves by frequencies to send the modulated physical values. For example, in the case of implementing a pulse signal repeated with a constant frequency (i.e., repeated with PRF), the frequencies may be re-divided by making the frequency, pulse length, pulse interval, the number of pulse waves, polarization, phase, and strength differ for each pulse frequency.

Meanwhile, as described above, the contents of Korean Patent Application No. 10-2014-0108341 and the contents of Korean Patent Application No. 10-2014-0139081 are all incorporated in the description of the present disclosure. As mentioned in Korean Patent Application No. 10-2014-0108341, a wearable device may generate a 3D model through 3D scanning of a part of a user's body through various methods. Further, the wearable device may generate a 3D model of a part of the body using only a depth sensor. Hereinafter, FIG. 4 will be described in association with the contents of the prior patent applications.

FIG. 4 is a diagram explaining the operation process of a wearable device according to an embodiment of the present disclosure. With reference to FIG. 4, a process will be described in which a wearable device compensates for an effective signal calculated with reference to FIGS. 2A, 2B, and 3 through analysis of an optical image.

First, the process of calculating the spatial location of the target object using the microwaves has been described with reference to FIGS. 2A, 2B, and 3. The microwaves penetrate an obstacle in the process of arriving at the target object, and the obstacle may be a thing or a part of a human body. If the obstacle is a part of the body, the thickness of the body that the microwaves should penetrate may differ depending on a user and regions of body tissue and thus is unable to be evenly determined. Further, the refractive index of the microwaves on the obstacle and the reflection rate on the target object are also unable to be specified. Further, if the microwaves are scattered several times in the obstacle (e.g., in the body tissue), physical property values, such as a phase, polarization, and strength, are changed. Since insignificant signals that do not arrive at the target object, but are scattered in the body are to be filtered, the wearable device detects the effective signal (signal including information on a distance, location, and direction for the target object) through filtering the received signals using the above-described phase difference, wide band frequency, frequency (or phase) modulation method, and beamforming method. Then, it is necessary to compensate for the result of calculation for the effective signal of the microwaves. Hereinafter, a process of compensating for the spatial location of the target object through an optical image for the object will be described.

The object that is a target of an optical image is different from the target object. For example, if the wearable device that is implemented in the shape of glasses sends the microwaves to the target object in the case where the target object is a finger tip, the microwaves should penetrate an obstacle that is a hand to arrive at the target object. In this case, the object that is the target of the optical image becomes the back of a user's hand and the finger. That is, the wearable device may generate the optical image for the user's hand and the back thereof, and may estimate the location of the finger tip that is the target object through analysis of the optical image. If the effective signal that is detected through the microwaves is compensated for using the value estimated through the optical image, the spatial location of the finger tip that is the target object can be specified more precisely.

In FIG. 4, x/y/z axes represent a 3D space and lines connecting the origin and points P1, P2, P3, and P4 represent a frame from a user's wrist to a finger if an object is a user's hand. That is, the origin represents the center of the wrist, the point P1 represents a joint connecting the palm to the first phalange of the finger, the point P2 represents a joint connecting the first phalange to the second phalange of the finger, the point P3 represents a joint connecting the second phalange to the third phalange of the finger, and point P4 represents the tip of the finger.

In the case where the wearable device generates an optical image for a user's hand that is an object using various sensors as described above with reference to FIG. 1, it can grasp locations of the origin and the points P1 and P2 that can be visually confirmed although it cannot directly confirm information on the user's finger tip that is the target object. Further, the wearable device can also confirm an angle θ1 of the point P1 connecting the user's palm and the first phalange of the finger and an angle θ2 of the point P2 connecting the first phalange and the second phalange. Calculation of a 3D location of the point P2 means calculation of a distance d1 from the center of the wrist to the point P2.

On the assumption that a user's finger is bent according to a natural motion, if the coordinates of the point P1, the coordinates of the point P2, and the angles θ1 and θ2 are given, all of the coordinates of the point P3, the angle θ3 and the coordinates of the point P4 may be calculated. Such a process may be carried out by an experimental method, i.e., estimation by experience. However, unless the user consciously bends finger joints by abnormal angles, the coordinates of the point P3 and the angle θ3 may be calculated with high precision from relations among the coordinates of the point P1, the coordinates of the point P2, and the angles θ1 and θ2. Further, similarly, the location information of the point P4 may be precisely calculated from relations among the coordinates of the point P1, the coordinates of the point P2, the coordinates of the point P3, and the angles θ1, θ2 and θ3.

In the above-described process, the ranges of the angles θ1, θ2 and θ3 may become an issue. That is, the angles θ1, θ2 and θ3 need to be within 180 degrees. If a user raises a finger highly, a joint connecting the user's palm and the first phalange of the finger may be 180 degrees or more. However, such an angle is far from a normal key input motion. Therefore, during a process of measuring the angles θ1, θ2 and θ3 of the joints, the wearable device may acquire only values of angles which are within 180 degrees as significant values. The wearable device may be implemented so as to ignore values of the angles θ1, θ2 and θ3 which are greater than 180 degrees, or to map the angles θ1, θ2 and θ3 which are greater than 180 degrees to a specific motion.

There are various methods to improve precision in such an estimation process. For example, after generation of the 3D model of a hand is initially carried out according to at least one of the methods provided in Korean Patent Application No. 10-2014-0108341 and Korean Patent Application No. 10-2014-0139081, the wearable device may instruct a user to perform a motion to input a specific key. When the user makes a natural motion to input the corresponding key, the wearable device may sense such a motion and foreknow which value needs to be compensated for during the estimation process of the point P3, the point P4, and the angle θ3. That is, software compensation may be carried out during a process of calculating an input value according to a user's key input motion.

As another method, the wearable device may directly measure the 3D location of the point P3 and the angle θ3. That is, if it is possible to confirm even the vicinity of the joint connecting the second phalange and the third phalange of the finger from the optical image, the wearable device may measure the 3D location of the corresponding joint and the bending angle thereof. In this case, since the wearable device directly measures the points P1, P2, and P3, the angles θ1, θ2, and θ3 and a distance d2, precision in estimation of the point P4 is greatly raised. Otherwise, the above-described software compensation method may be carried out together with the method of directly measuring the point P3 and the angle θ3.

As a result, the wearable device may estimate the spatial location of the target object through generating the optical image for the object. If experimental processes are carried out several times with respect to a user who wears the wearable device for the first time, high precision can be expected in the process of estimating the location using the optical image.

By compensating for the result of calculating the microwaves as described above with reference to FIGS. 2A, 2B, and 3 using the optical image, precise spatial location can be obtained through improvement of the result of calculating the microwaves, and it is possible to match the result of calculating the microwaves with the optical image. Further, the effective signal generated by the wearable device can be compensated for through generation of the optical image of the target object at an angle at which an external device having an image generator that interlocks with the wearable device is not hidden by the obstacle, and it is possible to match the optical image with the effective signal. More specifically, if the wearable device predicts and estimates the spatial location of the target object from the optical image, it can be aware of brief information on the reception time of the microwaves reflected from the target object. That is, the wearable device can be aware of information on the distance from the optical image to the target object; and, because information on the transmission speed of the microwaves is given in advance, the wearable device can pre-calculate information on a time when the microwaves are reflected and received. Accordingly, the wearable device may perform a filtering process in which it is recognized that the microwaves received earlier or later than an error range of the predicted time are not signals reflected from the target object. That is, the result of estimation from the optical image may be utilized in the process of detecting the effective signal. As described above, the reception time of the microwaves can be limited simultaneously with limitation of the reception order of the microwaves. If the microwaves having two or more frequencies are successively transmitted, the microwaves reflected from the same target object are to be received in the order of the transmitted frequencies. As described above, the effective signal can be detected in consideration of the reception order of the microwaves together.

Schemes for the wearable device to efficiently detect the effective signal through limiting a part of the physical properties of the microwaves using the optical image will be additionally described.

Through further extension of the concept of the frequency modulation method as described above, the antenna array may change the phase, strength, time interval, and polarization state according to time in addition to the frequency to transmit and receive the microwaves, and it may measure and divide the flight time of each of the received microwaves. As described above, the wearable device can briefly be aware of the reception time of the microwaves in advance through the optical image, and it can pre-calculate the strength of the reflected microwaves through the value estimated from the optical image. Low strength of the reflected microwaves may mean that there has been much scattering on the obstacle, and high strength of the reflected microwaves compared with the expected strength may mean that the microwaves are reflected from the obstacle rather than from the target object. Simultaneously with limitation of the strength of the microwaves, the strength of the microwaves may be considered in association with the distance to the target object. Since transmission of the microwaves over a long distance means a high probability that the microwaves are scattered during the length of penetrating the obstacle and in space, the strength of the microwaves that are received through a longer optical path length should be lower. Accordingly, the resultant values that are in proportion to the optical path length and the strength of the received microwaves may be filtered.

As described above, by pre-filtering candidate values of the received microwaves through the optical image, the wearable device can greatly reduce the calculation complexity required in the process of detecting the effective signal.

Further, the wearable device may store the calculation result of the microwaves to match the used optical image in order to compensate for the calculation result, and such a matching relationship is utilized in the process of analyzing the microwaves next time to contribute to the improvement of a data processing speed. That is, after securing a sufficient database, the wearable device can promptly compensate for the effective signal through loading the optical image corresponding to the property value of the effective signal without the necessity of compensation through the optical image whenever the wearable device analyzes the microwaves. Through such a machine learning process, both the data processing speed and precision of the result can be secured.

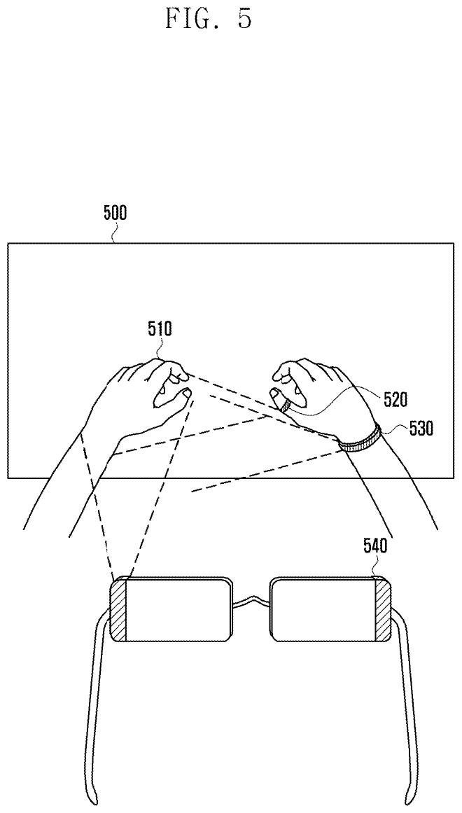

FIG. 5 is a diagram explaining the operation process of a wearable device according to an embodiment of the present disclosure. As described above, the process of detecting the effective signal using the microwave has been described with reference to FIGS. 2A, 2B, and 3, and the process of compensating for the effective signal using the optical image has been described with reference to FIG. 4. With reference to FIG. 5, the operation process of the wearable device will be generally described.

As described above with reference to FIG. 1, the wearable device may be implemented in various shapes of glasses, ring, or bracelet. FIG. 5 illustrates a process in which a user wearing the wearable device operates the wearable device in a state where the user puts his/her hands on an external surface 500 of the wearable device. FIG. 5 illustrates an embodiment in which the wearable device senses the finger tip of the left hand as a target object 510, and a ring shape 520 mounted on the right hand, a bracelet shape or a watch shape 530, and glasses shape 540 mounted on the face are illustrated in FIG. 5. Even if the wearable device is implemented in any shape, it is difficult to directly observe the target object 510, and a process of calculating a spatial location of the target object through the process as described above with reference to FIGS. 1A to 4 will be described.

If a motion of a user who wears the wearable device is sensed, the wearable device generates an optical image for a user's hand, and/or sends microwaves to the finger tip that is a target object with reference to the optical image after generating the optical image. Through the process as described above with reference to FIGS. 2A to 4, the wearable device may calculate a spatial location of the target object.

Meanwhile, the wearable device should be aware of not only the target object but also information on the external surface 500 which the target object comes in contact with. The wearable device may sense the external surface 500 in various ways. For example, in the same manner as a method for generating the optical image for the hand that is the object, the wearable device may generate the optical image for the external surface 500 using a depth sensor, acceleration sensor, and gyro sensor. The wearable device compares a spatial location of the target object that is confirmed using the microwaves with a spatial location of the external surface 500 that is sensed using the optical image, and at a moment when it is determined that the target object comes in contact with the optical image (e.g., at a moment when it is determined that coordinates of a height axis of the target object become sufficiently close to the external surface), the wearable device recognizes that a user's key input operation is sensed. That is, at the moment when the target object comes in contact with the external surface 500, the wearable device generates an input value corresponding to the spatial location of the target object. In contrast, the external surface 500 may be confirmed using microwaves in the same manner as the target object rather than the optical image. Since the location of the external surface 500 can be determined even through microwaves, the key input value can be generated similarly to the above-described method even though the external surface 500 is sensed in a different method.

Obtaining the incident angle of the microwaves has been described. The strength of the reflected microwaves being received differs in accordance with an angle at which the microwaves are incident to the target object and the degree of polarization, and if the external surface 500 and the target object are hidden by an obstacle as in the above-described embodiment, the incident angle is estimated through analysis of the optical image to facilitate the analysis of the external surface 500. That is, the angle (i.e., incident angle) at which the wearable device views the external surface 500 or the target object can be estimated through analysis of the optical image, and analysis of the external surface 500 and the target object can be efficiently carried out through analysis of the strength of the received microwaves and the degree of polarization together with the incident angle.

As another example, it may be considered that the wearable device sets the target object as the external surface 500 other than the finger tip. That is, the wearable device senses the external surface 500 through the optical image, and it determines whether the finger tip comes in contact with the external surface 500 using the microwaves. In this embodiment, the wearable device determines whether the user's finger tip comes in contact with the external surface in accordance with a change of the microwaves through continuous sensing of a location which the user's finger tip comes in contact with on the external surface 500.

In the above-described process of sensing the key input operation, a moving target indicator (MTI) technique may be introduced. The MTI technique is a technique selectively detecting only the moving target object while disregarding a non-moving obstacle on the basis of the Doppler phenomenon; and, in the present disclosure, it may be combined with a process of regularly sending microwave pulses. If the MTI technique is introduced, the microwaves are received with a phase change in accordance with a motion of the finger tip that is the target object, and the motion of the target object is determined through the selective detection process. If the MTI technique is used in addition to the contents as described above with reference to FIGS. 2A to 4, it is possible to perform a data process that is concentrated on a fingertip and analyze the result to improve efficiency.

Different from the illustrated embodiment, an embodiment in which the wearable device senses a user's mouse input operation and a mouse click operation will be described. Such an embodiment will be described on the assumption that the user's finger tip is sensed in the air without the external surface 500 in FIG. 5.

The wearable device sends the microwaves to the user's finger tip that is the target object. The wearable device can grasp the spatial locations of two or more finger tips by sending the microwaves to the two or more finger tips that are target objects and compensating for effective signal values from the optical image for the hand. On the other hand, if a user performs a mouse input operation in a space, the wearable device may generate a cursor value for moving a mouse cursor in accordance with motions of the finger tip, the back of the hand, and the wrist using the above-described optical image or the signal transceiver. Further, if the user undertakes a mouse click operation that is an operation to make the thumb come in contact with the second and third finger tips in the space, the wearable device continuously senses locations of the finger tips, and if the two fingers come in contact with each other, the wearable device generates a mouse click value. As described above, the wearable device may operate as a space mouse.

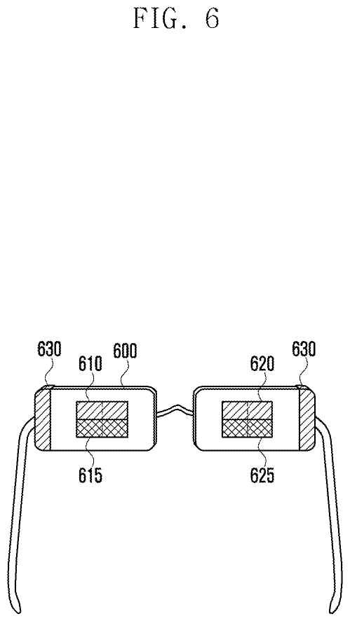

FIG. 6 is a diagram explaining an implementation example of a wearable device according to an embodiment of the present disclosure. FIG. 6 illustrates an embodiment in which a wearable device 600 is implemented in the shape of glasses.

A wearable device 600 implemented in the shape of glasses may be implemented to include a housing 630 attached to spectacle lenses having several configurations as described above with reference to FIG. 1. That is, since it is difficult to attach hardware configurations to the spectacle lenses, a separate housing 630 may be provided to mount several configurations.

The wearable device 600 implemented in the shape of glasses senses a user's hand from top to bottom on the basis of a height-axis direction. Accordingly, the object from which the optical image is generated becomes a user's hand, the back of a hand, and a part of a finger.

Meanwhile, among the configurations of the wearable device 600, the signal transceiver composed of a plurality of antennas may be provided on the housing 630, or it may be implemented in the shape that is attached to the spectacle lenses. In the case where the wearable device 600 implements the signal transceiver using transparent antennas made of a material, such as transparent conducting oxide (TCO) or conductive ink, the transparent antennas have high conductivity with respect to the microwaves and thus have metal properties. On the other hand, because the transparent antennas have low conductivity with respect to a light signal of a visible light region and thus have light-penetrating properties, they do not disturb the user's operation even if they are attached to the spectacle lenses. As described above, the signal transceiver that is implemented as the transparent antennas may be attached to an outer surface of the spectacle lenses or may be inserted into the inside of the spectacle lenses.

Meanwhile, as an example of the wearable device 600 implemented in the shape of glasses, the concept of the antenna array as described above with reference to FIGS. 2A and 2B will be further described. The signal transceiver of the wearable device 600 includes a plurality of antennas, and the plurality of antennas may be grouped into two or more antenna arrays. As a simple implementation of the antenna arrays, antennas attached to the left spectacle lens may be grouped into a first antenna array 610, and antennas attached to the right spectacle lens may be grouped into a second antenna array 620. In this case, because the beamformed microwaves are sent and received through the left and right spectacle lenses and the microwaves are sent to the target object in a state where they are spaced apart from each other for binocular parallax, the microwaves received in the two antenna arrays have great deviation.

The antenna arrays may be implemented to be further sub-divided on the respective spectacle lenses. That is, the first antenna array 610 may be divided into the (1-1)-th antenna array 610 and the (1-2)-th antenna array 615 at top and bottom, and the second antenna array 620 may be divided into the (2-1)-th antenna array 620 and the (2-2)-th antenna array 625 at top and bottom. If the signal transceiver is divided into four antenna arrays, the calculation complexity is raised, but more precise spatial location of the target object can be acquired. The embodiment for grouping the antenna arrays is not limited to the number thereof or location relations thereof. As illustrated as a dotted line in FIG. 6, the signal transceiver may be further sub-divided into 8 antenna arrays, or may be divided in other shapes.

FIG. 7 is a diagram explaining an implementation example of a wearable device according to an embodiment of the present disclosure. FIG. 7 illustrates an embodiment in which a wearable device 700 is implemented in the shape of a ring.

A wearable device 700 implemented in the shape of a ring senses a user's finger tip in a state where it is spaced apart in left and right directions. Accordingly, an object from which an optical image is generated becomes a user's hand or a side surface of a finger. A signal transceiver for sending a target object and the object may be provided on a side surface 720 that is a location for sensing the opposite hand, and on a lower surface 710 that is a location directed to an external surface, various kinds of sensor unit (e.g., depth sensor for sensing the external surface and the like) or an image outputter for outputting an image to the external surface may be provided. The detailed process of transmitting and receiving the optical image and the microwaves may be carried out in the same manner as or in a similar manner to the contents as described above with reference to FIGS. 2A to 5.

If the wearable device 700 is implemented in the shape of a ring, it may 3D-recognize a user's face and may recognize a motion of the eye pupil. As an algorithm to recognize a part of a user's body, a method using various sensors for depth sensing, vein sensing, iris sensing using visible light or infrared rays, RGB sensing, and infrared sensing may be proposed. If a motion of the eye pupil is sensed, the wearable device 700 may project different images onto both eyes in consideration of binocular parallax, and may enable a user to recognize projection of a 2D or 3D image in a constant location through following the motion of the eye pupil.

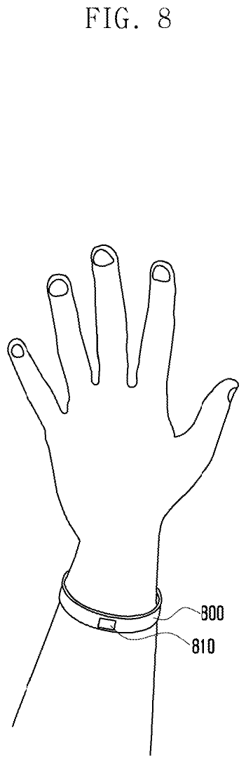

FIG. 8 is a diagram explaining an implementation example of a wearable device according to an embodiment of the present disclosure. FIG. 8 illustrates an embodiment in which a wearable device 800 is implemented in the shape of a bracelet or a watch.

A wearable device 800 implemented in the shape of a bracelet or a watch senses the back of a user's hand in a state where it is spaced apart in front and rear directions. Accordingly, an object from which an optical image is generated becomes the back of a user's hand. An image generator, a sensor unit, and a signal transceiver may be provided in a location 810 that is directed upward in a height-axis direction, and it may be provided in a location (not illustrated) that is directed downward in the height-axis direction so as to directly photograph the user's palm. The detailed process of transmitting and receiving the optical image and the microwaves may be carried out in the same manner as or in a similar manner to the contents as described above with reference to FIGS. 2A to 5.

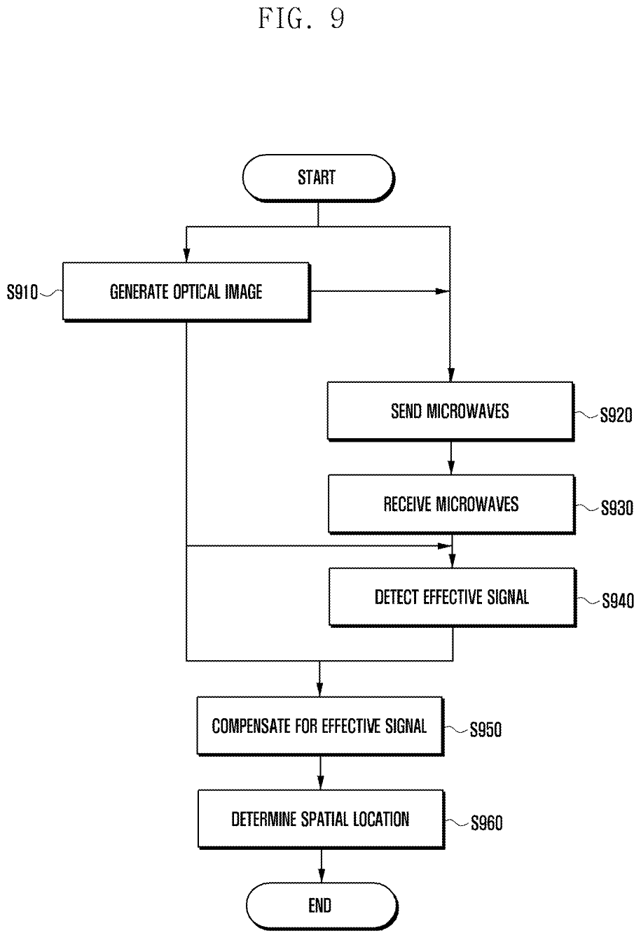

FIG. 9 is a flowchart explaining a method for determining a location of a wearable device according to an embodiment of the present disclosure. FIG. 9 illustrates the operation process of the wearable device as described above with reference to FIGS. 1 to 8 according to time-series flow. Although the detailed contents are omitted from the flowchart of FIG. 9, it can be easily understood by those skilled in the art that the contents as described above with reference to FIGS. 1 to 8 can be equally or similarly applied.

First, the wearable device generates an optical image for an object (S910). Then, the wearable device may estimate a location for a target object through analysis of the optical image for the object. If the location of the target object is estimated, the wearable device sends microwaves to the location that is determined on the basis of the optical image (S920). Then, the wearable device receives the microwaves reflected from the target object (S930) and detects an effective signal that is a candidate value for a spatial location of the target object through comparing and analyzing physical properties of the received microwaves (S940). In the process of detecting the effective signal, the wearable device may use the optical image generated at operation S910. That is, the wearable device may determine the location from which the microwaves are sent at operation S920 using the optical image, and it may pre-calculate physical values (microwave strength, reception time, phase, and polarization) that are expected when the microwaves are reflected in the estimated location. Accordingly, the wearable device filters wrong signals (microwaves that are scattered or do not arrive at the target object) including insignificant information through filtering the received microwaves using pre-calculated values and detects the effective signal.

Meanwhile, the effective signal is a value received through an unconfirmed refractive index as the microwaves penetrate an obstacle, and high precision cannot be guaranteed. Accordingly, the wearable device acquires an estimated value for the spatial location of the target object from the optical image generated at operation S910, and it compensates for the effective signal using the estimated value (S950). The wearable device finally determines the spatial location of the target object on the basis of the compensated effective signal (S960).

In addition, although not clearly illustrated in FIG. 9, the wearable device stores the compensated effective signal and the optical image that is used to compensate for the corresponding effective signal so that the effective signal matches the optical image, and it may use them in performing an additional location determination process in addition to the series of processes as described above with reference to FIG. 9. That is, if the effective signal detected from the received microwave is similar to the previously detected effective signal to the extent over a threshold value, the wearable device loads and uses the optical image that matches the effective signal, and thus an additional process that is consumed for analysis of the optical image and compensation for the effective signal may be omitted.

It will be understood that the above-described embodiments are exemplary to help those of ordinary skill in the art to which the embodiments of the present disclosure pertains easily understand the contents of the present disclosure and do not limit the scope of the present disclosure. Accordingly, the scope of the present disclosure is defined by the appended claims, and it will be construed that all corrections and modifications derived from the meanings and scope of the following claims and the equivalent concept fall within the scope of the present disclosure.

What is claimed is:

1. A device comprising:
an image generator configured to generate an optical image for a body part of a user;
a signal transceiver composed of a plurality of antennas and configured to send microwave signals toward the body part on the basis of the optical image and receive reflected signals, wherein the received reflected signals include a first reflected signal which is reflected from the body part and a second reflected signal which penetrates the body part and is reflected from a target object located beyond the body part from a view of the device; and
a signal processor configured to estimate a position of the body part based on the optical image and to detect an effective signal through processing the received reflected signals by using the optical image,
wherein the signal processor is further configured to detect that the effective signal has penetrated the body part and been reflected by the target object, by filtering out signals received from the position estimated by the optical image.

2. The device of claim 1, wherein the signal processor is further configured to
generate a value to be used for a compensation of at least one physical property of microwaves corresponding to a received signal value from the body part on the basis of the generated optical image,
compare the received reflected signals with the value for the compensation,
filter out the signals having a difference above a threshold on the basis of a result of the comparing, and
detect the effective signal having the difference above the threshold.

3. The device of claim 2, wherein the signal processor is further configured to detect the effective signal by extracting at least one signal having a same light-path length with each other among the received reflected signals, and
wherein the same light-path length comprises a length from the signal transceiver to the target object via the body part.

4. The device of claim 2, wherein the signal transceiver is further configured to send a first microwave signal having a first frequency and receive a second microwave signal obtained as the first microwave is reflected from the target object,
wherein the signal processor is further configured to
determine a first phase angle of the second microwave signal having the first frequency by comparing a phase of the second microwave signal with a phase of a reference microwave signal having the first frequency, and
detect the effective signal through comparing phase differences between the first phase angle and a second phase angle determined by sending and receiving a microwave having a second frequency that is different from the first frequency, and
wherein the effective signal comprises signals having the phase differences below a threshold.

5. The device of claim 2, wherein the signal transceiver is further configured to send a first microwave signal having a specific frequency band and receives a second microwave signal obtained as the first microwave is reflected from the target object, and
wherein the signal processor is further configured to detect the effective signal by comparing a reference microwave and the second microwave with each other in a time domain or a frequency domain.

6. The device of claim 2, wherein the signal transceiver is further configured to send a first microwave signal through modulating at least one of a frequency and a phase in accordance with a time change and receive a second microwave signal obtained as the first microwave is reflected from the target object,
wherein the signal transceiver is further configured to determine a spatial location of the target object by comparing at least one of a frequency and a phase of the second microwave signal with at least one of the modulated frequency and the modulated phase, and
wherein the effective signal comprises signals having at least one of a frequency difference and a phase difference below a threshold.

7. The device of claim 1, wherein the effective signal is a candidate value for a spatial location of the target object,
wherein the effective signal includes information on a distance or a direction of the target object with respect to the signal transceiver, and
wherein the signal transceiver is further configured to determine the spatial location of the target object by calculating the distance or the direction.

8. The device of claim 1, wherein the signal transceiver is further configured to send the microwave signals by beamforming signals with a directivity from an antenna array,
wherein the signal processor is further configured to detect the effective signal in consideration of a directivity of the received reflected signals, and
wherein the effective signal is similar to a previously detected effective signal to an extent over a threshold value.

9. The device of claim 8, wherein the antenna array includes a plurality of antennas, and the antenna array sends the microwave signals through the beamforming the microwave signals in a specific direction, and
wherein the plurality of antennas are transparent antennas having a higher conductivity with respect to the microwave signals.

10. The device of claim 8, wherein the signal processor detects the effective signal through comparing and analyzing the received reflected signals which are received through two or more antenna arrays.

11. The device of claim 1, wherein the image generator is further configured to generate the optical image using at least one of an infrared sensor, a depth sensor, and an RGB sensor, and
wherein the signal processor is further configured to estimate a spatial location of the body part by calculating a distance or a direction of the body part with respect to the image generator based on the optical image.

12. The device of claim 7, wherein the device senses an external surface through the image generator or the signal transceiver,
wherein the signal processor is further configured to determine whether the target object comes in contact with the external surface by comparing a spatial location of the target object with the external surface.

13. The device of claim 1, wherein the device comprises a wearable device to be mounted on a user's face, head or body.

14. The device of claim 1, wherein the device further comprises a storage configured to store a plurality of optical images,
wherein each of the plurality of images is mapped to a signal value to be received corresponding to a spatial location of a position of the body part based on the optical image.

15. The device of claim 14, wherein the signal processor is further configured to detect the effective signal by:
loading a related optical image from the plurality of images stored in the storage, the related optical image having a correlation with the optical image,
obtain signal values from the related optical image,
compare the obtained signal values with a compensation value of the optical image, and filter out signals having a difference above a threshold on the basis of a result of the comparing.

16. The device of claim 7, wherein the signal processor is further configured to:
determine 3-dimension (3D) locations of a first joint connecting a user's palm to a first phalange of a finger and a second joint connecting the first phalange to a second phalange of the finger from the optical image for the object, and
compensate for the effective signal on the basis of the 3D locations of the first joint and the second joint.

17. The device of claim 16, wherein the signal processor is further configured to:
determine the 3D locations of the first joint and the second joint and bending angles of the first joint and the second joint, and
compensate for the effective signal on the basis of the 3D location of the first joint and second joint and the bending angles of the first joint and second joint.

18. A method by a device, the method comprising:
generating, by an image generator, an optical image for a body part of a user;
estimating, by a signal processor, a position of the body part based on the optical image;
sending, by a signal transceiver composed of a plurality of antennas, microwave signals toward the body part on the basis of the optical image;
receiving, by the signal transceiver, reflected signals, wherein the received reflected signals include a first reflected signal which is reflected from the body part and a second reflected signal which penetrates the body part and is reflected from a target object located beyond the body part from a view of the device; and
detecting, by the signal processor, an effective signal through processing the received reflected signals by using the optical image,
wherein the detecting comprises detecting the effective signal has penetrated the body part and been reflected by the target object, by filtering out signals received from the position estimated by the optical image.
